(19) United States
(12) Patent Application Publication
(10) Pub. No.: US 2024/0393163 A1
(43) Pub. Date: Nov. 28, 2024

(54) OPTICAL FIBER SENSING SYSTEM, OPTICAL FIBER SENSING DEVICE, AND ROAD MONITORING METHOD

(71) Applicant: NEC Corporation, Minato-ku, Tokyo (JP)

(72) Inventors: Masatake Takahashi, Tokyo (JP); Hitoshi Sakurai, Tokyo (JP); Yuma Matsuda, Tokyo (JP)

(73) Assignee: NEC Corporation, Minato-ku, Tokyo (JP)

(21) Appl. No.: 18/690,773

(22) PCT Filed: Sep. 28, 2021
(86) PCT No.: PCT/JP2021/035577

§ 371 Date: Mar. 11, 2024

(51) Int. Cl. G01H 9/00; G01D 5/353; G01K 11/32; G06V 20/52

(52) U.S. Cl. CPC G01H 9/004; G01D 5/35358; G01K 11/32; G06V 20/52

(57) ABSTRACT

A system includes: an optical fiber laid along a road; a sensing unit configured to receive an optical signal from the optical fiber and detect vibration generated by a vehicle traveling on the road based on the optical signal; a calculation unit configured to calculate vibration data indicating the vibration; a traveling state detection unit configured to detect, for each vehicle traveling on the road, a vehicle speed of the vehicle and an inter-vehicle distance based on the vibration data; a vehicle group detection unit configured to detect, as a dangerous vehicle group, a vehicle group of which the vehicle speed is equal to or higher than a speed threshold and of which an inter-vehicle distance is equal to or shorter than a distance threshold; and a broadcasting unit configured to broadcast the detection of the dangerous vehicle group to a predetermined broadcasting destination.

### TECHNICAL FIELD

The present disclosure relates to an optical fiber sensing system, an optical fiber sensing device, and a road monitoring method.

### BACKGROUND ART

In recent years, a system for monitoring a situation of a road has been proposed.

For example, Patent Literature 1 discloses that an impact sensor is fixed to a guardrail or the like of a road, and when a level of an electric signal output from the impact sensor is equal to or higher than a threshold, an accident detection signal indicating that a traffic accident has occurred is generated.

### CITATION LIST

### Patent Literature

Patent Literature 1: Japanese Unexamined Patent Application Publication No. 2000-227989

### SUMMARY OF INVENTION

### Technical Problem

Recently, there is a demand for knowing whether or not a dangerous vehicle group that may lead to a traffic accident exists on a road. Examples of the dangerous vehicle group include a vehicle group traveling at a high speed with a short inter-vehicle distance. If such a dangerous vehicle group can be known in advance, a measure such as dispatch of an emergency vehicle can be taken, which can contribute to suppression of occurrence of a traffic accident.

However, the technology disclosed in Patent Literature 1 can only detect whether or not a traffic accident has occurred on a road.

Therefore, an object of the present disclosure is to solve the above-described problems and to provide an optical fiber sensing system, an optical fiber sensing device, and a road monitoring method capable of knowing whether or not a dangerous vehicle group exists on a road.

### Solution to Problem

An optical fiber sensing system according to an aspect includes:
an optical fiber laid along a road;
a sensing unit configured to receive an optical signal from the optical fiber and detect vibration generated by a vehicle traveling on the road based on the optical signal;
a vibration data calculation unit configured to calculate vibration data indicating the vibration;
a traveling state detection unit configured to detect, for each vehicle traveling on the road, a vehicle speed of the vehicle and an inter-vehicle distance between the vehicle and a preceding vehicle or a following vehicle based on the vibration data;
a vehicle group detection unit configured to detect, as a dangerous vehicle group, a vehicle group of which a vehicle speed is equal to or higher than a speed threshold and of which an inter-vehicle distance is equal to or shorter than a distance threshold; and
a broadcasting unit configured to broadcast, when the dangerous vehicle group has been detected, the detection of the dangerous vehicle group to a predetermined broadcasting destination.

An optical fiber sensing device according to an aspect includes;
a sensing unit configured to receive an optical signal from an optical fiber laid along a road and detect vibration generated by a vehicle traveling on the road based on the optical signal;
a vibration data calculation unit configured to calculate vibration data indicating the vibration;
a traveling state detection unit configured to detect, for each vehicle traveling on the road, a vehicle speed of the vehicle and an inter-vehicle distance between the vehicle and a preceding vehicle or a following vehicle based on the vibration data;
a vehicle group detection unit configured to detect, as a dangerous vehicle group, a vehicle group of which a vehicle speed is equal to or higher than a speed threshold and of which an inter-vehicle distance is equal to or shorter than a distance threshold; and
a broadcasting unit configured to broadcast, when the dangerous vehicle group has been detected, the detection of the dangerous vehicle group to a predetermined broadcasting destination.

A road monitoring method according to an aspect is
a road monitoring method by an optical fiber sensing device, the road monitoring method including:
a sensing step of receiving an optical signal from an optical fiber laid along a road and detecting vibration generated by a vehicle traveling on the road based on the optical signal;
a vibration data calculation step of calculating vibration data indicating the vibration;
a traveling state detection step of detecting, for each vehicle traveling on the road, a vehicle speed of the vehicle and detecting an inter-vehicle distance between the vehicle and a preceding vehicle or a following vehicle based on the vibration data;
a vehicle group detection step of detecting, as a dangerous vehicle group, a vehicle group of which a vehicle speed is equal to or higher than a speed threshold and of which an inter-vehicle distance is equal to or shorter than a distance threshold; and
a broadcasting step of broadcasting, when the dangerous vehicle group has been detected, the detection of the dangerous vehicle group to a predetermined broadcasting destination.

### Advantageous Effects of Invention

According to the above-described aspects, it is possible to provide an optical fiber sensing system, an optical fiber sensing device, and a road monitoring method capable of knowing whether or not a dangerous vehicle group exists on a road.

### BRIEF DESCRIPTION OF DRAWINGS

FIG. 1 is a diagram illustrating a configuration example of an optical fiber sensing system according to a first example embodiment.

FIG. 2 is a diagram for describing an example of vibration data calculated by a vibration data calculation unit according to the first example embodiment.

FIG. 3 is a flowchart for describing a schematic operation example in a case where a dangerous vehicle group is detected in the optical fiber sensing system according to the first example embodiment.

FIG. 4 is a diagram illustrating a configuration example of an optical fiber sensing system according to a second example embodiment.

FIG. 5 is a flowchart for describing a schematic operation example in a case where a speed threshold and a distance threshold are changed in the optical fiber sensing system according to the second example embodiment.

FIG. 6 is a diagram illustrating a configuration example of an optical fiber sensing device according to another example embodiment.

FIG. 7 is a block diagram illustrating a hardware configuration example of a computer that implements the optical fiber sensing device according to another example embodiment.

### EXAMPLE EMBODIMENT

Example embodiments of the present disclosure are described below with reference to the drawings. Note that in the description and drawings to be described below, omission and simplification are made as appropriate, for clarity of description. Furthermore, in the following drawings, the same elements will be denoted by the same reference signs, and redundant description will be omitted as necessary.

### First Example Embodiment

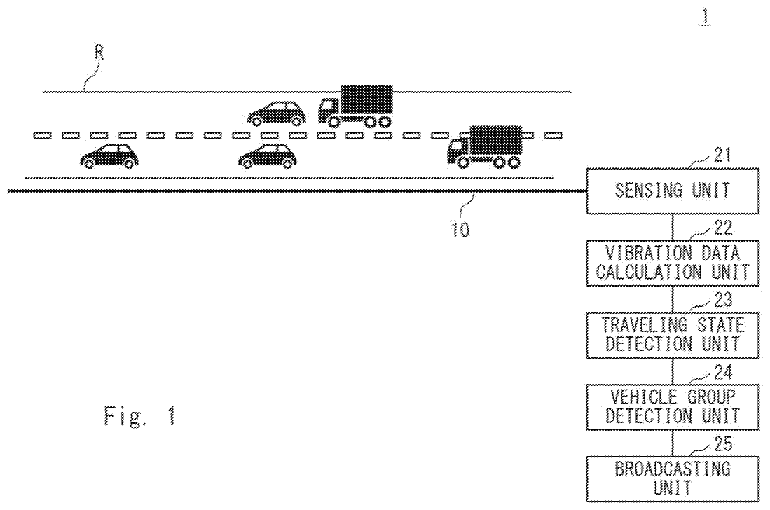

First, a configuration example of an optical fiber sensing system 1 according to a first example embodiment will be described with reference to FIG. 1.

As illustrated in FIG. 1, the optical fiber sensing system 1 according to the first example embodiment includes an optical fiber 10, a sensing unit 21, a vibration data calculation unit 22, a traveling state detection unit 23, a vehicle group detection unit 24, and a broadcasting unit 25.

The optical fiber 10 is laid along a road R. In FIG. 1, it is assumed that the optical fiber 10 is buried in the road R, but a method of laying the optical fiber 10 is not limited thereto. For example, the optical fiber 10 may be aerially wired to a structure such as a utility pole along the road R.

The sensing unit 21 is connected to the optical fiber 10 laid along the road R.

Therefore, the sensing unit 21 is installed near the road R. On the other hand, the vibration data calculation unit 22, the traveling state detection unit 23, the vehicle group detection unit 24, and the broadcasting unit 25, which will be described later, may be installed in any place, for example, on a cloud.

The sensing unit 21 causes pulsed light to be incident on the optical fiber 10. In addition, the sensing unit 21 receives backscattered light generated as the pulsed light is transmitted through the optical fiber 10 as an optical signal via the optical fiber 10.

When a vehicle travels on the road R, vibration specific to traveling of the vehicle is generated, and the vibration is transmitted to the optical fiber 10 laid along the road R. As a result, characteristics (for example, a wavelength) of the optical signal transmitted through the optical fiber 10 are changed.

Therefore, the sensing unit 21 can detect the vibration generated by the vehicle traveling on the road R based on the optical signal received from the optical fiber 10.

The vibration data calculation unit 22 calculates vibration data indicating the vibration detected by the sensing unit 21 based on the optical signal received from the optical fiber 10 by the sensing unit 21. For example, the vibration data calculation unit 22 calculates the vibration data as follows.

First, the vibration data calculation unit 22 calculates a position and time at which the vibration detected by the sensing unit 21 has been generated.

Among the position and the time, the position at which the vibration has been generated is calculated as follows, for example.

For example, it is possible to calculate the position at which the optical signal is generated (a distance of the optical fiber 10 from the sensing unit 21) based on a time difference between a time at which the pulsed light is incident on the optical fiber 10 by the sensing unit 21 and a time at which the optical signal is received from the optical fiber 10 by the sensing unit 21.

Therefore, in a case where the sensing unit 21 detects the vibration based on the optical signal, it is sufficient if the vibration data calculation unit 22 calculates the position at which the optical signal is generated by the above-described method, and sets the calculated position as the position at which the vibration is generated.

Then, the vibration data calculation unit 22 calculates, as the vibration data, a graph with a horizontal axis representing the position at which the vibration has been generated and a vertical axis representing the time at which the vibration has been generated, based on the position and time at which the vibration has been generated, the position and time being calculated as described above.

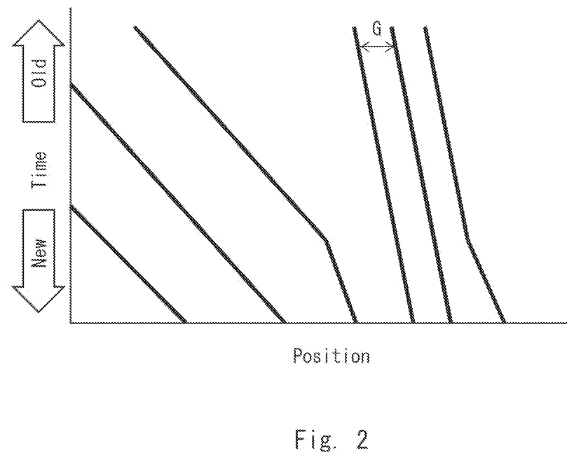

Here, an example of the vibration data calculated by the vibration data calculation unit 22 will be described with reference to FIG. 2. In FIG. 2, the horizontal axis represents the position at which the vibration has been generated (the distance of the optical fiber 10 from the sensing unit 21), and the vertical axis represents the time lapse of the time at which the vibration has been generated. In addition, the vertical axis indicates older data toward a positive direction.

In the vibration data illustrated in FIG. 2, the fact that one vehicle is traveling on the road R over time is represented by one oblique line. An absolute value of an inclination of the line represents the vehicle speed of the vehicle, and the smaller the absolute value of the inclination of the line, the higher the vehicle speed of the vehicle. The positive and negative inclinations of the line represent a traveling direction of the vehicle. For example, in a case where there are a vehicle corresponding to a line with a positive inclination and a vehicle corresponding to a line with a negative inclination, the lines mean that the vehicles are traveling in opposite directions to each other (for example, traveling in opposite lanes). A change in inclination of the line indicates that the vehicle is accelerated or decelerated. Further, an interval G between the lines in a horizontal axis direction represents an inter-vehicle distance between the vehicles, and the shorter the interval G, the shorter the inter-vehicle distance.

The traveling state detection unit 23 detects the vehicle speed of each vehicle traveling on the road R and detects the inter-vehicle distance between the vehicle and a preceding vehicle or a following vehicle based on the vibration data (for example, the vibration data as illustrated in FIG. 2) calculated by the vibration data calculation unit 22. The inter-vehicle distance to either the preceding vehicle or the following vehicle may be arbitrarily determined. In the example of FIG. 2, six lines are illustrated, which means that six vehicles corresponding to the six lines are traveling on the road R. Therefore, the traveling state detection unit 23 detects the vehicle speed and the inter-vehicle distance for each of the six vehicles.

The vehicle group detection unit 24 holds a speed threshold which is a threshold for the vehicle speed and a distance threshold which is a threshold for the inter-vehicle distance as thresholds used for determining a dangerous vehicle group. The speed threshold may be, for example, a speed limit set for the road R. Furthermore, it is conceivable to set the distance threshold to an arbitrary value such as 5 m, for example.

The vehicle group detection unit 24 detects, as the dangerous vehicle group, a vehicle group of which the vehicle speed is equal to or higher than the speed threshold and of which the inter-vehicle distance is equal to or shorter than the distance threshold based on the vehicle speed and the inter-vehicle distance of each vehicle traveling on the road R detected by the traveling state detection unit 23.

In a case where the vehicle group detection unit 24 has detected a dangerous vehicle group of which the vehicle speed is equal to or higher than the speed threshold and of which the inter-vehicle distance is equal to or shorter than the distance threshold, the broadcasting unit 25 broadcasts the detection of the dangerous vehicle group to a predetermined broadcasting destination. The predetermined broadcasting destination may be arbitrarily set. For example, in a case where the road R is an expressway, it is conceivable to set a road control center as the predetermined broadcasting destination. A broadcasting method may be any method. For example, a graphical user interface (GUI) screen may be displayed on a display, a monitor, or the like of a terminal of the broadcasting destination, or a message may be output by voice from a speaker of the terminal of the broadcasting destination.

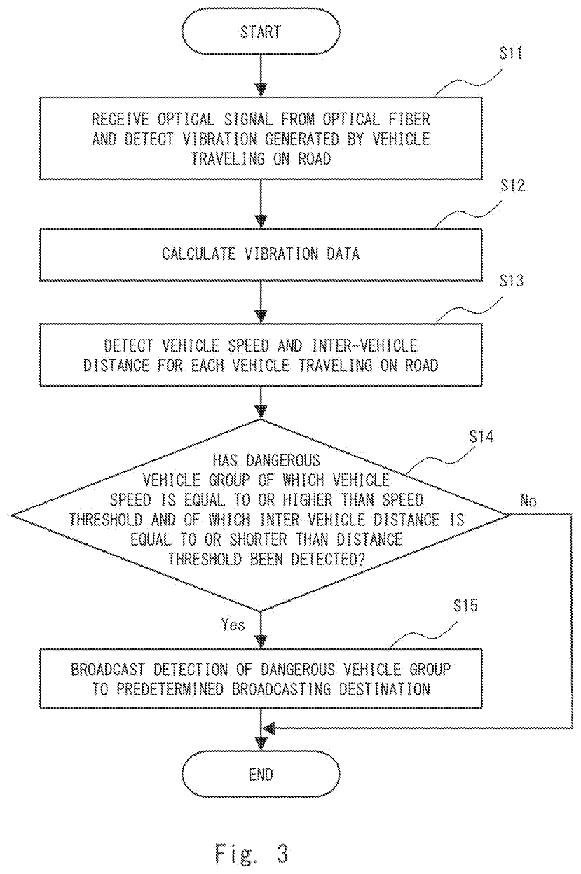

Subsequently, a schematic operation example in a case where the dangerous vehicle group is detected in the optical fiber sensing system 1 according to the first example embodiment will be described with reference to FIG. 3.

As illustrated in FIG. 3, the sensing unit 21 receives the optical signal from the optical fiber 10, and detects the vibration generated by the vehicle traveling on the road R based on the received optical signal (step S11).

Next, the vibration data calculation unit 22 calculates the vibration data indicating the vibration detected by the sensing unit 21 based on the optical signal received from the optical fiber 10 by the sensing unit 21 (step S12). For example, the vibration data calculation unit 22 calculates the vibration data as illustrated in FIG. 2.

Next, the traveling state detection unit 23 detects, for each vehicle traveling on the road R, the vehicle speed and the inter-vehicle distance based on the vibration data calculated by the vibration data calculation unit 22 (step S13).

Next, the vehicle group detection unit 24 detects, as the dangerous vehicle group, a vehicle group of which the vehicle speed is equal to or higher than the speed threshold and of which the inter-vehicle distance is equal to or shorter than the distance threshold based on the vehicle speed and the inter-vehicle distance of each vehicle traveling on the road R detected by the traveling state detection unit 23 (step S14).

In step S14, when the dangerous vehicle group has been detected by the vehicle group detection unit 24 (Yes in step S14), the broadcasting unit 25 broadcasts the detection of the dangerous vehicle group to the predetermined broadcasting destination (step S15). On the other hand, when no dangerous vehicle group has been detected (No in step S14), the processing ends.

As described above, according to the first example embodiment, the sensing unit 21 detects the vibration generated by the vehicle traveling on the road R based on the optical signal received from the optical fiber 10. The vibration data calculation unit 22 calculates the vibration data indicating the vibration. The traveling state detection unit 23 detects, for each vehicle traveling on the road R, the vehicle speed and the inter-vehicle distance based on the vibration data. The vehicle group detection unit 24 detects, as the dangerous vehicle group, a vehicle group of which the vehicle speed is equal to or higher than the speed threshold and of which the inter-vehicle distance is equal to or shorter than the distance threshold. When the dangerous vehicle group has been detected, the broadcasting unit 25 broadcasts the detection of the dangerous vehicle group to the predetermined broadcasting destination.

As a result, the broadcasting destination can know whether or not a dangerous vehicle group that may lead to a traffic accident exists on the road R. Therefore, when there is a dangerous vehicle group on the road R, the broadcasting destination can take a measure such as dispatch of an emergency vehicle, which can contribute to suppression of occurrence of a traffic accident.

### Second Example Embodiment

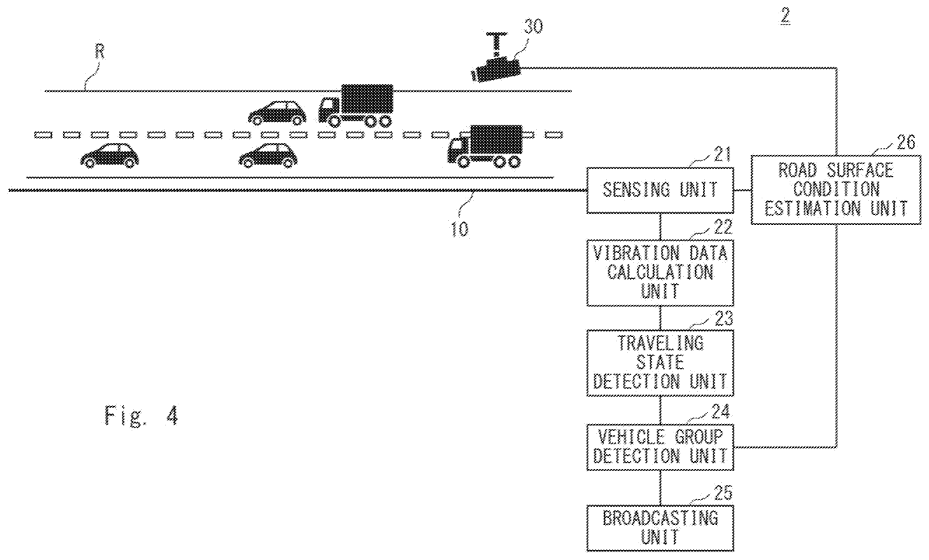

Next, a configuration example of an optical fiber sensing system 2 according to a second example embodiment will be described with reference to FIG. 4.

As illustrated in FIG. 4, the optical fiber sensing system 2 according to the second example embodiment is different from the above-described first example embodiment in that a road surface condition estimation unit 26 and a camera 30 are added. Although only one camera 30 is provided in FIG. 4, a plurality of cameras 30 may be provided.

The camera 30 is a camera that captures an image of a road R. The camera 30 is implemented by, for example, a fixed camera, a pan tilt zoom (PTZ) camera, or the like.

The road surface condition estimation unit 26 estimates a road surface condition of the road R. The road surface condition of the road R is, for example, a dry condition, a wet condition, a semi-wet condition, a snowfall condition, a frozen condition, or the like. For example, the road surface condition estimation unit 26 estimates the road surface condition of the road R as follows.

When a temperature of the road R is changed, characteristics (for example, a wavelength) of an optical signal transmitted through an optical fiber 10 laid along the road R are changed.

Therefore, a sensing unit 21 can also detect the temperature of the road R based on the optical signal received from the optical fiber 10.

In addition, in recent years, many weather information providing services have been provided, and it is possible to easily acquire weather information indicating weather around the road R by using these services.

Therefore, the road surface condition estimation unit 26 acquires weather information near the road R and also acquires temperature information of the road R detected by the sensing unit 21, and estimates the road surface condition of the road R based on the temperature of the road R and the weather near the road R.

At this time, the road surface condition estimation unit 26 may construct in advance a learning model that outputs the road surface condition of the road R by using the temperature of the road R and the weather near the road R as inputs, and may estimate the road surface condition of the road R by using the constructed learning model. In this case, examples of a learning method of the learning model described above include supervised learning using data of a set of temperature and weather and training data indicating a road surface condition at a corresponding time, but are not particularly limited.

In a case where the camera 30 is installed on the road R, the road surface condition estimation unit 26 may estimate the road surface condition of the road R by further using a captured image of the road R captured by the camera 30. That is, the road surface condition estimation unit 26 may further acquire the captured image of the road R captured by the camera 30, and estimate the road surface condition of the road R based on the temperature of the road R, the weather near the road R, and the captured image of the road R.

A vehicle group detection unit 24 changes a speed threshold and a distance threshold based on the road surface condition of the road R estimated by the road surface condition estimation unit 26.

For example, in a state in which the road R is frozen, since the vehicle is slippery compared to a state in which the road R is dry, it is necessary to further increase the inter-vehicle distance and further reduce the vehicle speed in order to avoid a traffic accident. Therefore, in the second example embodiment, the speed threshold and the distance threshold for detecting a dangerous vehicle group are changed according to the road surface condition of the road R. Specifically, in the frozen, the speed threshold is made lower and the distance threshold is made longer than in the dry state.

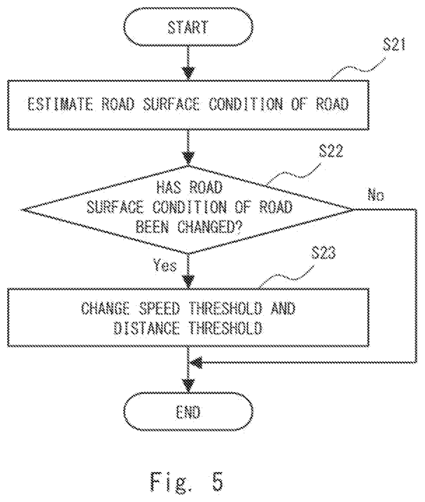

Subsequently, a schematic operation example in a case where the speed threshold and the distance threshold are changed in the optical fiber sensing system 2 according to the second example embodiment will be described with reference to FIG. 5.

As illustrated in FIG. 5, the road surface condition estimation unit 26 estimates the road surface condition of the road R (step S21).

Next, the vehicle group detection unit 24 determines whether or not there is a change in road surface condition of the road R based on the road surface condition of the road R estimated by the road surface condition estimation unit 26 (step S22). For example, when the road R having a certain road surface condition (for example, dry) has been changed to another road surface condition (for example, wet, semi-wet, snowfall, or frozen), the vehicle group detection unit 24 determines that the road surface condition has been changed.

In step S22, when there is a change in road surface condition of the road R (Yes in step S22), the vehicle group detection unit 24 changes the speed threshold and the distance threshold according to the changed road surface condition (step S23). On the other hand, when there is no change in road surface condition of the road R (No in step S22), the processing ends.

The second example embodiment is different from the first example embodiment described above only in that the speed threshold and the distance threshold are changed according to the road surface condition of the road R.

Therefore, in the second example embodiment, an operation in a case of detecting a dangerous vehicle group is similar to the operation of FIG. 3 described above except that the speed threshold and the distance threshold changed according to the road surface condition of the road R are used. Therefore, in the second example embodiment, a description of the operation in a case of detecting a dangerous vehicle group is omitted.

As described above, according to the second example embodiment, the road surface condition estimation unit 26 estimates the road surface condition of the road R. The vehicle group detection unit 24 changes the speed threshold and the distance threshold based on the road surface condition of the road R.

As a result, it is possible to change a vehicle group regarded as dangerous according to the road surface condition of the road R. For example, in the frozen state, even a vehicle group having a lower vehicle speed and a longer inter-vehicle distance when compared to the dry state can be regarded as a dangerous vehicle group.

### Another Example Embodiment

In the above-described first example embodiment, the sensing unit 21, the vibration data calculation unit 22, the traveling state detection unit 23, the vehicle group detection unit 24, and the broadcasting unit 25 are separately provided, but these components may be collectively provided in one device (optical fiber sensing device).

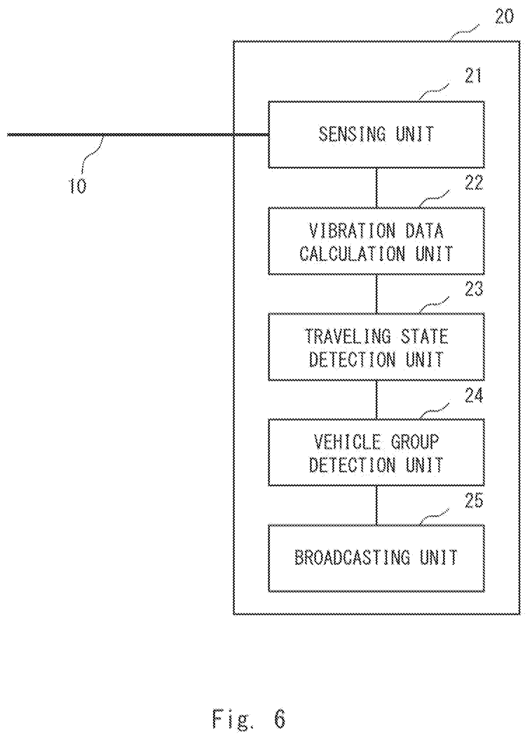

A configuration example of an optical fiber sensing device 20 according to another example embodiment will be described with reference to FIG. 6. As illustrated in FIG. 6, the optical fiber sensing device 20 according to another example embodiment includes a sensing unit 21, a vibration data calculation unit 22, a traveling state detection unit 23, a vehicle group detection unit 24, and a broadcasting unit 25. The optical fiber sensing device 20 may further include the road surface condition estimation unit 26 according to the second example embodiment described above.

### <Hardware Configuration of Optical Fiber Sensing Device According to Another Example Embodiment>

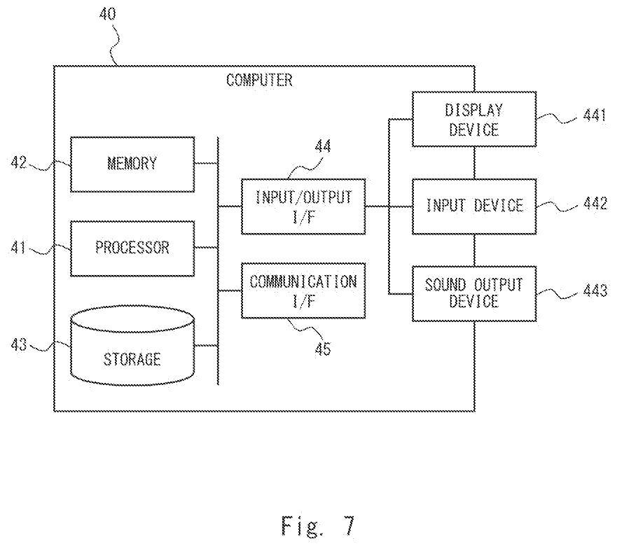

Subsequently, a hardware configuration example of a computer 40 that implements the optical fiber sensing device 20 according to the above-described another example embodiment is described with reference to FIG. 7.

As illustrated in FIG. 7, the computer 40 includes a processor 41, a memory 42, a storage 43, an input/output interface (input/output I/F) 44, and a communication interface (communication I/F) 45. The processor 41, the memory 42, the storage 43, the input/output interface 44, and the communication interface 45 are connected by a data transmission line for mutually transmitting or receiving data.

The processor 41 is an arithmetic processing apparatus such as a central processing unit (CPU) or a graphics processing unit (GPU). The memory 42 is a memory such as a random access memory (RAM) or a read only memory (ROM). The storage 43 is a storage device such as a hard disk drive (HDD), a solid state drive (SSD), or a memory card. Furthermore, the storage 43 may be a memory such as a RAM or a ROM.

A program is stored in the storage 43. This program includes a group of commands (or software code) for causing the computer 40 to execute one or more functions of the optical fiber sensing device 20 described above when being read by the computer. The sensing unit 21, the vibration data calculation unit 22, the traveling state detection unit 23, the vehicle group detection unit 24, the broadcasting unit 25, and the road surface condition estimation unit 26 in the optical fiber sensing device 20 described above may be implemented by the processor 41 reading and executing the program stored in the storage 43. In addition, the storage function in the optical fiber sensing device 20 described above may be implemented by the memory 42 or the storage 43.

Furthermore, the program may be stored in a non-transitory computer readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 44 is connected to a display device 441, an input device 442, a sound output device 443, and the like. The display device 441 is a device that displays a screen corresponding to drawing data processed by the processor 41, such as a liquid crystal display (LCD), a cathode ray tube (CRT) display, or a monitor. The input device 442 is a device that receives an input of an operation of the operator, and is, for example, a keyboard, a mouse, a touch sensor, or the like. The display device 441 and the input device 442 may be integrated, and may be implemented as a touch panel. The sound output device 443 is a device that acoustically outputs sound corresponding to acoustic data that has been processed by the processor 41, such as a speaker.

The communication interface 45 transmits or receives data to and from an external device. For example, the communication interface 45 performs communication with the external device via a wired communication line or a wireless communication line.

Although the present disclosure has been described with reference to the example embodiments, the present disclosure is not limited to the example embodiments described above. Various modifications that can be understood by those skilled in the art can be made to the configuration and details of the present disclosure within the scope of the present disclosure.

Furthermore, some or all of the above example embodiments may be described as the following Supplementary Notes but are not limited to the following.

### Supplementary Note 1

An optical fiber sensing system including:
an optical fiber laid along a road;
a sensing unit configured to receive an optical signal from the optical fiber and detect vibration generated by a vehicle traveling on the road based on the optical signal;
a vibration data calculation unit configured to calculate vibration data indicating the vibration;
a traveling state detection unit configured to detect, for each vehicle traveling on the road, a vehicle speed of the vehicle and an inter-vehicle distance between the vehicle and a preceding vehicle or a following vehicle based on the vibration data;
a vehicle group detection unit configured to detect, as a dangerous vehicle group, a vehicle group of which the vehicle speed is equal to or higher than a speed threshold and of which the inter-vehicle distance is equal to or shorter than a distance threshold; and
a broadcasting unit configured to broadcast, when the dangerous vehicle group has been detected, the detection of the dangerous vehicle group to a predetermined broadcasting destination.

### Supplementary Note 2

The optical fiber sensing system according to Supplementary Note 1, in which the vibration data calculation unit calculates a position and a time at which the vibration has been generated based on the optical signal, and calculates, as the vibration data, a graph with a horizontal axis representing the position at which the vibration has been generated and a vertical axis representing the time at which the vibration has been generated.

### Supplementary Note 3

The optical fiber sensing system according to Supplementary Note 1 or 2, further including a road surface condition estimation unit configured to estimate a road surface condition of the road,
in which the vehicle group detection unit changes the speed threshold and the distance threshold based on the road surface condition of the road.

### Supplementary Note 4

The optical fiber sensing system according to Supplementary Note 3, in which
the sensing unit further detects a temperature of the road based on the optical signal, and
the road surface condition estimation unit acquires weather information near the road and estimates the road surface condition of the road based on the temperature of the road and the weather near the road.

### Supplementary Note 5

The optical fiber sensing system according to Supplementary Note 4, further including a camera configured to capture an image of the road,
in which the road surface condition estimation unit estimates the road surface condition of the road based on the temperature of the road, the weather near the road, and the captured image of the road.

### Supplementary Note 6

An optical fiber sensing device including:
a sensing unit configured to receive an optical signal from an optical fiber laid along a road and detect vibration generated by a vehicle traveling on the road based on the optical signal;
a vibration data calculation unit configured to calculate vibration data indicating the vibration;
a traveling state detection unit configured to detect, for each vehicle traveling on the road, a vehicle speed of the vehicle and an inter-vehicle distance between the vehicle and a preceding vehicle or a following vehicle based on the vibration data;
a vehicle group detection unit configured to detect, as a dangerous vehicle group, a vehicle group of which the vehicle speed is equal to or higher than a speed threshold and of which the inter-vehicle distance is equal to or shorter than a distance threshold; and
a broadcasting unit configured to broadcast, when the dangerous vehicle group has been detected, the detection of the dangerous vehicle group to a predetermined broadcasting destination.

### Supplementary Note 7

The optical fiber sensing device according to Supplementary Note 6, in which the vibration data calculation unit calculates a position and a time at which the vibration has been generated based on the optical signal, and calculates, as the vibration data, a graph with a horizontal axis representing the position at which the vibration has been generated and a vertical axis representing the time at which the vibration has been generated.

### Supplementary Note 8

The optical fiber sensing device according to Supplementary Note 6 or 7, further including a road surface condition estimation unit configured to estimate a road surface condition of the road,
in which the vehicle group detection unit changes the speed threshold and the distance threshold based on the road surface condition of the road.

### Supplementary Note 9

The optical fiber sensing device according to Supplementary Note 8, in which
the sensing unit further detects a temperature of the road based on the optical signal, and
the road surface condition estimation unit acquires weather information near the road and estimates the road surface condition of the road based on the temperature of the road and the weather near the road.

### Supplementary Note 10

The optical fiber sensing device according to Supplementary Note 9, in which the road surface condition estimation unit acquires a captured image of the road captured by a camera and estimates the road surface condition of the road based on the temperature of the road, the weather near the road, and the captured image of the road.

### Supplementary Note 11

A road monitoring method by an optical fiber sensing device, the road monitoring method including:
a sensing step of receiving an optical signal from an optical fiber laid along a road and detecting vibration generated by a vehicle traveling on the road based on the optical signal;
a vibration data calculation step of calculating vibration data indicating the vibration;
a traveling state detection step of detecting, for each vehicle traveling on the road, a vehicle speed of the vehicle based on the vibration data and detecting an inter-vehicle distance between the vehicle and a preceding vehicle or a following vehicle;
a vehicle group detection step of detecting, as a dangerous vehicle group, a vehicle group of which the vehicle speed is equal to or higher than a speed threshold and of which the inter-vehicle distance is equal to or shorter than a distance threshold; and
a broadcasting step of broadcasting, when the dangerous vehicle group has been detected, the detection of the dangerous vehicle group to a predetermined broadcasting destination.

### Supplementary Note 12

The road monitoring method according to Supplementary Note 11, in which
in the vibration data calculation step, a position and a time at which the vibration has been generated are calculated based on the optical signal, and
a graph with a horizontal axis representing the position at which the vibration has been generated and a vertical axis representing the time at which the vibration has been generated is calculated as the vibration data.

### Supplementary Note 13

The road monitoring method according to Supplementary Note 11 or 12, further including a road surface condition estimation step of estimating a road surface condition of the road,
in which in the vehicle group detection step, the speed threshold and the distance threshold are changed based on the road surface condition of the road.

### Supplementary Note 14

The road monitoring method according to Supplementary Note 13, in which
in the sensing step, a temperature of the road is further detected based on the optical signal, and
in the road surface condition estimation step, weather information near the road is acquired, and the road surface condition of the road is estimated based on the temperature of the road and the weather near the road.

### Supplementary Note 15

The road monitoring method according to Supplementary Note 14, in which
in the road surface condition estimation step, a captured image of the road captured by a camera is acquired, and
the road surface condition of the road is estimated based on the temperature of the road, the weather near the road, and the captured image of the road.

### REFERENCE SIGNS LIST

1, 2 OPTICAL FIBER SENSING SYSTEM
10 OPTICAL FIBER
20 OPTICAL FIBER SENSING DEVICE
21 SENSING UNIT
22 VIBRATION DATA CALCULATION UNIT
23 TRAVELING STATE DETECTION UNIT
24 VEHICLE GROUP DETECTION UNIT
25 BROADCASTING UNIT
26 ROAD SURFACE CONDITION ESTIMATION UNIT
30 CAMERA
40 COMPUTER
41 PROCESSOR
42 MEMORY
43 STORAGE
44 INPUT/OUTPUT INTERFACE
441 DISPLAY DEVICE
442 INPUT DEVICE
443 SOUND OUTPUT DEVICE
45 COMMUNICATION INTERFACE
R ROAD

What is claimed is:

1. An optical fiber sensing system comprising:
an optical fiber laid along a road;
at least one memory storing instructions, and
at least one processor configured to execute the instructions to;
receive an optical signal from the optical fiber and detect vibration generated by a vehicle traveling on the road based on the optical signal;
calculate vibration data indicating the vibration;
detect, for each vehicle traveling on the road, a vehicle speed of the vehicle and an inter-vehicle distance between the vehicle and a preceding vehicle or a following vehicle based on the vibration data;
detect, as a dangerous vehicle group, a vehicle group of which the vehicle speed is equal to or higher than a speed threshold and of which the inter-vehicle distance is equal to or shorter than a distance threshold; and
broadcast, when the dangerous vehicle group has been detected, the detection of the dangerous vehicle group to a predetermined broadcasting destination.

2. The optical fiber sensing system according to claim 1, wherein the at least one processor is further configured to execute the instructions to calculate a position and a time at which the vibration has been generated based on the optical signal, and calculate, as the vibration data, a graph with a horizontal axis representing the position at which the vibration has been generated and a vertical axis representing the time at which the vibration has been generated.

3. The optical fiber sensing system according to claim 1, wherein the at least one processor is further configured to execute the instructions to
estimate a road surface condition of the road, and
change the speed threshold and the distance threshold based on the road surface condition of the road.

4. The optical fiber sensing system according to claim 3, wherein the at least one processor is further configured to execute the instructions to
detect a temperature of the road based on the optical signal, and
acquire weather information near the road, and
estimate the road surface condition of the road based on the temperature of the road and the weather near the road.

5. The optical fiber sensing system according to claim 4, further comprising a camera configured to capture an image of the road,
wherein the at least one processor is further configured to execute the instructions to estimate the road surface condition of the road based on the temperature of the road, the weather near the road, and the captured image of the road.

6. An optical fiber sensing device comprising:
at least one memory storing instructions, and
at least one processor configured to execute the instructions to;
receive an optical signal from an optical fiber laid along a road and detect vibration generated by a vehicle traveling on the road based on the optical signal;
calculate vibration data indicating the vibration;
detect, for each vehicle traveling on the road, a vehicle speed of the vehicle and an inter-vehicle distance between the vehicle and a preceding vehicle or a following vehicle based on the vibration data;
detect, as a dangerous vehicle group, a vehicle group of which the vehicle speed is equal to or higher than a speed threshold and of which the inter-vehicle distance is equal to or shorter than a distance threshold; and
broadcast, when the dangerous vehicle group has been detected, the detection of the dangerous vehicle group to a predetermined broadcasting destination.

7. The optical fiber sensing device according to claim 6, wherein the at least one processor is further configured to execute the instructions to calculate a position and a time at which the vibration has been generated based on the optical signal, and calculate, as the vibration data, a graph with a horizontal axis representing the position at which the vibration has been generated and a vertical axis representing the time at which the vibration has been generated.

8. The optical fiber sensing device according to claim 6, wherein the at least one processor is further configured to execute the instructions to
estimate a road surface condition of the road,
change the speed threshold and the distance threshold based on the road surface condition of the road.

9. The optical fiber sensing device according to claim 8, wherein the at least one processor is further configured to execute the instructions to
detect a temperature of the road based on the optical signal, and
acquire weather information near the road, and
estimate the road surface condition of the road based on the temperature of the road and the weather near the road.

10. The optical fiber sensing device according to claim 9, wherein the at least one processor is further configured to execute the instructions to
acquire a captured image of the road captured by a camera, and
estimate the road surface condition of the road based on the temperature of the road, the weather near the road, and the captured image of the road.

11. A road monitoring method by an optical fiber sensing device, the road monitoring method comprising:
a sensing step of receiving an optical signal from an optical fiber laid along a road and detecting vibration generated by a vehicle traveling on the road based on the optical signal;
a vibration data calculation step of calculating vibration data indicating the vibration;
a traveling state detection step of detecting, for each vehicle traveling on the road, a vehicle speed of the vehicle and detecting an inter-vehicle distance between the vehicle and a preceding vehicle or a following vehicle based on the vibration data;
a vehicle group detection step of detecting, as a dangerous vehicle group, a vehicle group of which the vehicle speed is equal to or higher than a speed threshold and of which the inter-vehicle distance is equal to or shorter than a distance threshold; and
a broadcasting step of broadcasting, when the dangerous vehicle group has been detected, the detection of the dangerous vehicle group to a predetermined broadcasting destination.

12. The road monitoring method according to claim 11, wherein
in the vibration data calculation step, a position and a time at which the vibration has been generated are calculated based on the optical signal, and
a graph with a horizontal axis representing the position at which the vibration has been generated and a vertical axis representing the time at which the vibration has been generated is calculated as the vibration data.

13. The road monitoring method according to claim 11, further comprising a road surface condition estimation step of estimating a road surface condition of the road,
wherein in the vehicle group detection step, the speed threshold and the distance threshold are changed based on the road surface condition of the road.

14. The road monitoring method according to claim 13, wherein
in the sensing step, a temperature of the road is further detected based on the optical signal, and
in the road surface condition estimation step, weather information near the road is acquired, and the road surface condition of the road is estimated based on the temperature of the road and the weather near the road.

15. The road monitoring method according to claim 14, wherein
in the road surface condition estimation step, a captured image of the road captured by a camera is acquired, and
the road surface condition of the road is estimated based on the temperature of the road, the weather near the road, and the captured image of the road.
